(19) United States
(12) Patent Application Publication
(10) Pub. No.: US 2009/0076833 A1
(43) Pub. Date: Mar. 19, 2009

(54) Management and Control Electronic System Particularly for Checking Articles Provided With an Identification Code

(76) Inventor: Gaetano Rizzi, Busto Arsizio (IT)

Correspondence Address: NEIL STEINBERG, 2300 M STREET, N.W., Suite 800, WASHINGTON, DC, 20037, US

(21) Appl. No.: 11/886,278

(22) PCT Filed: Jun. 9, 2005
(86) PCT No.: PCT/IT2005/000324

§ 371 Date: Oct. 6, 2008

(30) Foreign Application Priority Data
Mar. 14, 2005 (IT) TO2005A000160

(51) Int. Cl. G06Q 30/00; G01C 21/00; G06K 5/00

(52) U.S. Cl. 705/1; 701/300; 235/380

(57) ABSTRACT

An electronic management and check system is described, wherein a central system comprises a data storage system adapted to electronically store item codes used for identifying an item in an unambiguous way, as well as data processing means adapted to interrogate said data storage system and to interface with external communication systems. The invention is characterized in that said data storage system comprises memory areas containing position codes adapted to identify in an unambiguous way a position of said item, and in that said data processing means are adapted to receive a data string being organized in such a way as to separately identify an item code and a position code as well as to perform a comparison between the codes contained in said data string and the codes contained in said storage system.

The present invention relates to an electronic management and check system according to the preamble of claim 1, as well as to a method which may be implemented through said system. The invention particularly relates to management and check systems allowing for item traceability, i.e. giving the possibility of checking the source or position of single items. In the following, the term “item” will refer to a single object, such as an article of clothing. Such systems are also especially useful in the fight against the counterfeiting of items, in particular branded items, which has become a widespread phenomenon causing huge losses to companies.

The need of using deterrents allowing which permit to stop this phenomenon is therefore strongly felt.

In order to ensure the authenticity of items, thus limiting the propagation of counterfeiting phenomena, WO 93/22745 and U.S. Pat. No. 3,833,795 have provided for the use of univocal codes, typically bar codes, being generated randomly or pseudorandomly.

From the American Patent U.S. Pat. No. 6,442,276, it is known that these identification codes may be either visible or hidden, e.g. they may be written with inks being visible to infrared only. The same Patent also provides a system wherein a central computer generates the identification codes of the items and, besides printing them on labels, it stores them in a database. At the point of sale, a local computer is arranged which is able to communicate with said central computer, so as to compare the code on the item with the one contained in the database. In order to prevent a code from being copied and used more than once, the Patent U.S. Pat. No. 6,442,276 discloses the idea of checking, in addition to the validity of code, also that the code has not been used yet. To this purpose, the database contains a specific field which is marked when the item is sold.

The system and the method according to the Patent U.S. Pat. No. 6,442,276 therefore allow to check the authenticity of the label, not of the item; a possible theft of labels would actually allow to pass off counterfeited items as genuine ones.

In order to avoid this problem, WO 84/03019 provides a complex system according to which every warehouse, distributor and retailer should have a system which, by reading special item labels, checks the source and therefore the authenticity of the item and updates the database to trace the transfers of the item.

The user also has the possibility of checking the authenticity of the item by sending a label being present on the item itself.

However, this system has a plurality of drawbacks as well; first of all, the user can verify the authenticity of the item only following the purchase and anyway not in real time; secondly, the system does not allow to stop the counterfeiting in the event that the retailer is in bad faith and sells counterfeit items: as a matter of fact, this system does not allow for an immediate identification of the retailer who has sold the non-genuine item.

The main object of the present invention is therefore to provide a system and a method for checking items having a univocal identification code, said system and method adapted to solve the drawbacks and problems of the systems and methods known in the art.

Another object of the present invention is to provide a system and a method which allow to fight against the counterfeiting by using economical and effective systems.

Another object of the present invention is to allow the potential customer to verify immediately and with certainty the authenticity of the item that he/she wants to buy.

Said objects are achieved through a system and a method incorporating the features of the annexed claims, which form an integral part of the present description.

Further objects and advantages of the present invention will become apparent from the following description and annexed drawings, supplied by way of non-limiting example, wherein:

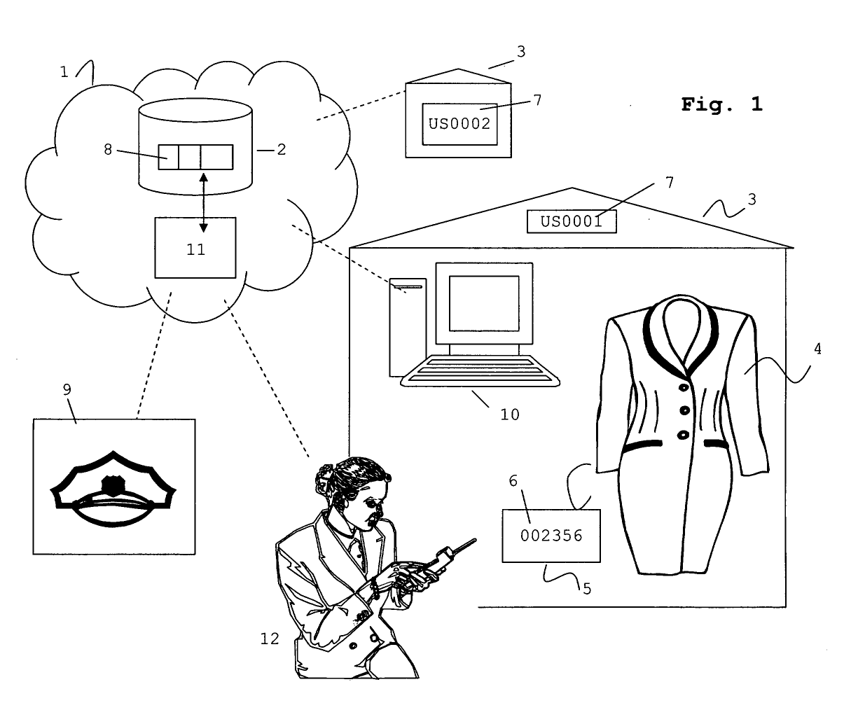

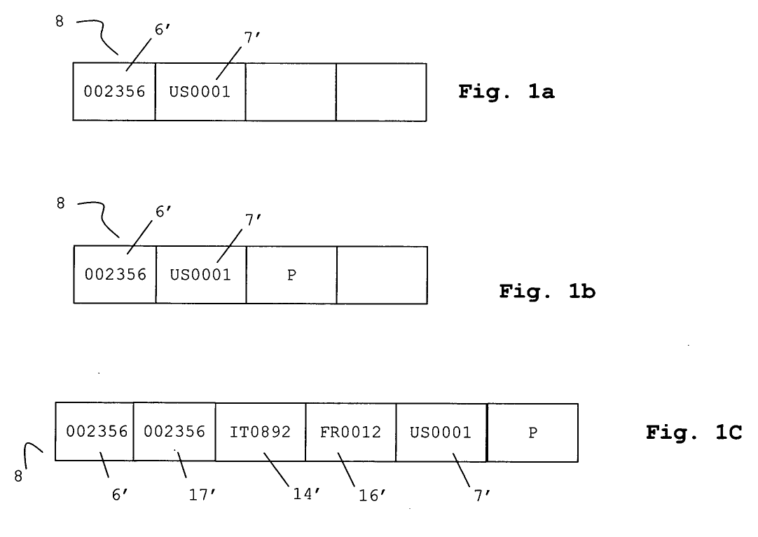

FIG. 1 shows an item check system according to the invention.

FIGS. 1a, 1b and 1c show some examples of records being present in the data storage system of the system according to the invention.

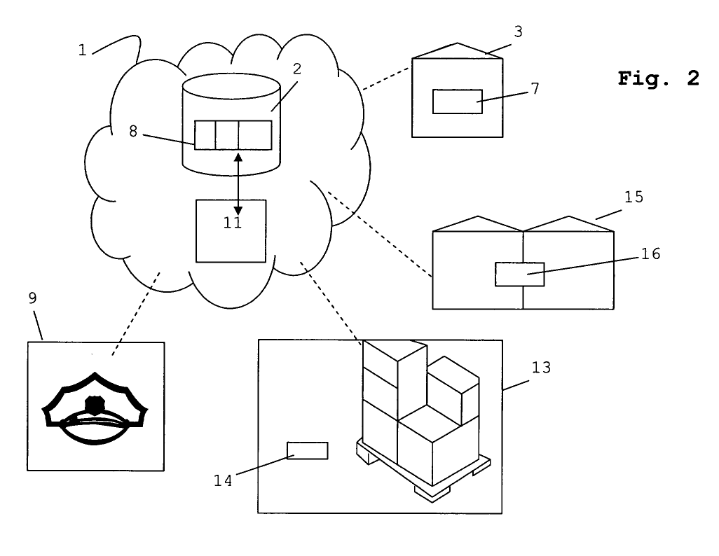

FIG. 2 shows a preferred embodiment of the system according to the invention.

FIG. 1 illustrates an electronic management and check system wherein a central system comprises:
a data storage system, in particular a database, adapted to electronically store item codes (6) used for identifying an item in an unambiguous way,
data processing means being adapted to interrogate said data storage system and to interface with external communication systems. The invention is characterized in that said data storage system comprises memory areas containing position codes adapted to identify in an unambiguous way a position of said item, and in that said data processing means are adapted to receive a data string being organized in such a way as to separately identify an item code and a position code as well as for performing a comparison between the codes contained in said data string and the codes contained in said storage system.

Preferably, the data processing means are adapted to receive a string of radiofrequency-transmitted data, said string being, for example, an SMS message sent by a user's telephone. The data processing means according to the invention are also adapted to send a return data string to said communication systems, said string being preferably in a format compatible with that of the received data string. Going back to the example of the SMS message, the external communication means may be a telephone or a laptop being connected to a mobile telephony network; the data processing means receive said SMS, process it and send a return SMS after having compared the codes contained in the data string with the codes stored in the data storage system.

In a particularly advantageous situation, the system comprises detection means adapted to detect the position of said external communication means, i.e. mobile phones sending SMS messages to verify products.

Such detection means may comprise a GPS (Global Positioning System) detection system associated with said external communication means, so as to allow to transmit a data string including the detected position as well.

If the communication means consist of mobile phones, then the detection means may be comprised in the mobile telephony network serving said telephones. It is in fact known that it is possible to detect the position of a mobile phone by detecting at least one coverage cell of said telephone.

The system according to the invention is therefore particularly adapted to implement a method for checking an item having at least one item code adapted to identify said item in an unambiguous way, wherein a user can perform a check of the authenticity of the item through a comparison between said item code and item codes stored in a data storage system associated with a remote system. FIG. 1 illustrates a system wherein a central system 1 comprises data processing means 11 and a data storage system 2, which stores item codes allowing to identify every item 3 on the market in an unambiguous way.

Such codes, being preferably of alphanumerical type, are reproduced, by printing or through a self-adhesive label, directly onto the items or their labels.

FIG. 1 also shows a shop 3 wherein items 4 are on sale (in this example, the item is an article of clothing), each of which is fitted with a label 5 whereon an item code 6 is reproduced.

In the present description, the term “shop” will refer to any point of sale where a final user may purchase an item.

In the example of FIG. 1, two shops have different position codes 7: US001 and US002. The position codes preferably comprise an alphabetic abbreviation, identifying the country where the shop is located, and a progressive number.

Anyway other types of coding may be used for identifying the shops in an unambiguous way. According to the invention, the shop 3 is assigned a position code 7 which identifies it in an unambiguous way.

The data storage system 2, which in the example of FIGS. 1 and 2 is placed within the central system, contains a position code of the authorized shop to which said item 4 has been supplied for being sold.

For every single item, the data storage system 2 therefore comprises a record 8, indicated in FIG. 1a, containing an item code 6′ and a position code 7′. The information contained in the data storage system thus allows to know where the genuine items must be.

The method according to the invention thus allows a user 12 to perform a check of the authenticity of the item through a comparison between said item code 6 and item codes 6′ stored in a data storage system located in a remote system. According to the inventive idea of this method, for every item the data storage system 2 also contains a position code of the shop where said item in on sale, so that said verification also comprises a comparison between a position code being present at the shop where the user sees or buys the item and said position code stored in said data storage system.

Thus, a user 12 being interested in buying an item 4 may, before buying it, perform a check of the authenticity of said item by comparing the item code 6 and the position code 7 with the data (6′,7′) stored in the data storage system.

The use of the position code is a tool that makes the shopkeeper responsible, and therefore the method and the system according to the invention allow to solve one of the problems of the known art, i.e. the impossibility of immediately tracing any frauds made by dishonest shopkeepers.

According to the invention, the check of the authenticity of the item may occur in a plurality of ways, e.g. by dialing a telephone number and communicating an item code and a position code to an operator; the operator will check in the data storage system if the item identified by the item code provided by the user 12 is a valid code and if said item should be in the shop whose position code matches the one provided by the user 12.

According to a preferred and economically advantageous embodiment, the method provides for an automatic check of the authenticity of items; in particular, the user 12 sends an electronic message to the central system 1 through suitable communication systems.

The term “electronic message” will hereafter refer to a data string, such as for example an SMS (Short Message Service) or an MMS (Multimedia Message Service) type message or any other type of electronic message, such as an electronic mail (e-mail) message, which may be sent through a mobile phone or any computer station, being it fixed (e.g. personal computer) or mobile (e.g. palmtop, laptop).

Among the possible choices, the SMS-type message is the most preferred one, in that it allows to provide a service (item check) at a very low cost. Moreover, the SMS message is a tool which is widely used and known by customers, who in front of any shop window have the possibility to check the authenticity of an item by sending an SMS with their telephone.

As already said, the use of an electronic message allows to perform an automatic check of the authenticity of an item, without needing a call center with operators performing the check through local terminals.

According to a preferred embodiment of the invention, the central system 1 which receives the electronic message sent by the user 12 comprises data processing means 11 adapted to receive data strings, in particular in the form of electronic messages, as well as to process and decode the received data, in particular the text of the message.

According to the invention, the message, and in particular the text of said message, contains an item code 6 and a position code 7.

The central system 1 receives the message sent by the user and compares the codes (6,7) contained in said string with the codes (6′,7′) stored in said data storage system 2.

If the codes contained in the message and the codes stored in the data storage system 2 match, the central system 1 will transmit a return message to confirm the authenticity of the item.

In a preferred and advantageous embodiment of the method according to the invention, for every item 4 the data storage system 2 also comprises a piece of information concerning the position of the authorized shop 3.

Said piece of information concerning the position of the shop 3 may consist of either geographical coordinates, i.e. latitude and longitude, or a civic address.

In this preferred embodiment of the invention, the record 8 of FIG. 1b thus comprises a field containing an item code 6′, a field containing a position code 7′, and a field containing a piece of information P (in particular, geographical coordinates or civic address) concerning the position of the shop.

The availability of this additional piece of information further improves the authenticity check, in that said check comprises a comparison between the position of the user 12 and the position P, stored in said data storage system, of the authorized shop.

The position of the user 12 may be detected, for instance, by tracing the origin of the message sent by the user 12, e.g. in case of an SMS or MMS message, said message carries a piece of information concerning the cell of the mobile telephony network with which the telephone is communicating.

The manager of the mobile telephony network can therefore send a piece of information concerning the position from which the message was originated to the central system 1.

By applying known triangulation techniques to the cells covering the telephone that sends the SMS message, this position information can be sufficiently accurate.

In some situations, such as large commercial areas, the accuracy provided by the detection system of the mobile telephony network manager might not be sufficient; for example, if at a distance of a hundred meters there are two shops selling items of the same brand, a better accuracy will be required to avoid any errors in the assessment of the authenticity of the items.

In this situation, the position of the user 12 may be detected through a GPS system (Global Positioning System) being associated with or integrated into the telephone sending said message and be transmitted along with said message.

According to a preferred embodiment of the invention, the central system 1 may be connected, via telephone line or any other known communication means, to a system 9 located in a police station, preferably a department being qualified on the subject of counterfeiting.

In the event that said check gives a negative result, the system 1 according to the invention may inform the police, preferably a department being qualified on the subject of counterfeiting.

Furthermore, if said check gives a negative result, the system 1 will send a warning message to said user 12. Preferably, if the message for checking the authenticity of the item was sent by the user 12 through a mobile phone, then the warning message transmitted by the central system 1 will be an SMS message.

The warning message may contain the detected position of the user and an exhortation to check the entered codes or to mistrust the authenticity of the item.

As a matter of fact, the codes sent by the user 12 and the codes contained in the record 8 of the data storage system 2 may not match due to a simple key-in mistake.

In a variant of the method and system according to the invention, when an item identified by an item code 6 is sold, said code is marked as no longer on sale in said data storage system 2. An eventual second use of said code would be proof of a counterfeit action and would initiate an immediate communication to the police through the above-described system.

From a technical viewpoint, the code may be marked as no longer on sale in the data storage system 2 in a plurality of ways; in particular, the shopkeeper may have a terminal 10 being connected to the central system 1. When the item is sold, the shopkeeper notifies the central system 1, through the terminal 10, that the item being identified in an unambiguous way by the item code 6 has been sold. This event may be recorded in the data storage system 2, for instance, by entering a flag in a field of the record 8 corresponding to the sold item.

In a further variant of the invention, following the sale of an item provided with an item code, the user 12 activates a warranty of said item by sending an SMS-type message to said service center.

By doing so, the purchaser activates the warranty and confirms the sale of the item to the system, thereby further improving the dependability of the system and method according to the invention.

When the warranty is activated, the central system 1 transmits a certification stating the transfer of title of the item, which is recorded in the data storage system of the central system and/or of the producer, so that at any time in the future it will be possible to confirm the right of the user 12 to own the item.

The system described so far therefore offers a low-cost solution for fighting against the sale of counterfeit items.

A further improvement of the method and system according to the invention comprises an additional phase for tracing the item from the producer to the point of sale; in particular, said phase provides for:
recording the sender and the receiver of the item in said data storage system;
at the next transfer, checking if the sender corresponds to the receiver recorded in the previous transfer and recording the new receiver in said data storage system.

Besides a shop 3 and the police 9, FIG. 2 also shows a warehouse 13 and a distributor 15, both of which have an unambiguous identification code (14 and 16, respectively) and are connected to the central system 1.

When an item 4 is sent by the producer, the item code 6′, the code of the sender (in this case the producer) and the code of the receiver (in this case the code of the warehouse 13) are entered into the record 8 being present in the data storage system 2.

Subsequently the item 4 is transferred from the warehouse 13 to the distributor 15. For this transfer as well, the sender and the receiver of the item are recorded in the record 8 of the data storage system 2. It is then also checked that the sender, i.e. the warehouse 13, corresponds to the receiver recorded for the previous transfer.

In this way it is possible to trace the item from the producer to the shop.

For a better definition of the above-described process, FIG. 1c shows an example of a record 8 being present in the data storage system 2; the different fields of the record are shown, which contain an item code 6′, a producer code 17′, a warehouse code 14′, a distributor code 16′ and a position code 7′.

It is also clear that further embodiments and variations of the present method and system are possible for those skilled in the art without departing from the inventive idea, as specified in the present description and in the annexed drawings and claims.

For example, the central system may be a distributed system, wherein the data storage system 2 may be physically separated from the data processing means 11, which are interfaced on one side with the data storage system in order to perform the item authenticity checks, and on the other side with the outer world, e.g. for receiving and sending the different electronic messages described herein.

It also clear that, notwithstanding a preferred application of the system according to the invention has been illustrated in the present description, said system may be used for applications in fields other than the fight against counterfeiting; in particular, in fields where it is anyway necessary or advantageous to have the possibility of verifying items of any kind, e.g. for warehouse management.

1. Electronic management and check system allowing for checking items authenticity, wherein a central system comprises a data storage system and data processing means,
wherein the data storage system electronically stores item codes each being adapted to identify an item in an unambiguous way, and
position codes each being adapted to identify in an unambiguous way a shop, the data storage system storing for each item an item code and a position code, whereby said position codes and said item codes contained in the data storage system allow to know where each item must be, and
wherein the data processing means are adapted to receive a data string being organized in such a way as to separately identify an item code and a position code of an item to be checked, and to interrogate said data storage system for performing a comparison between the codes contained in said data string and the codes contained in said storage system so as to check the authenticity of the item.

2. System according to claim 1, wherein said data processing means are adapted to receive a string of radiofrequency-transmitted data.

3. System according to claim 1 wherein said data processing means are adapted to send a return data string to said communication systems, said string being preferably in a format compatible with that of the received data string.

4. System according to claim 3, wherein the return data string depends on said comparison.

5. System according to claim 1, wherein said management and check system comprises detection means adapted to detect the position of external communication means transmitting the received data string.

6. System according to claim 5, wherein said detection means comprise a GPS (Global Positioning System) detection system being associated with said external communication means.

7. System according to claim 6, wherein said external communication means transmit a data string comprising said detected position.

8. System according to claim 5, wherein said external communication means consist of a mobile phone.

9. System according to claim 8, wherein said detection means are comprised in the mobile telephony network serving said mobile phone and are adapted to detect at least one coverage cell of said mobile phone.

10. System according to any of claims 5, 6, 7, 8 or 9, wherein for each item said data storage system stores a further piece of information relating to the position of said shop, and wherein said data processing means is adapted to compare said detected position with said further piece of information.

11. System according to claim 1, wherein said central system is connected to at least one system located at a police stations.

12. System according to claim 1, wherein it comprises at least one terminal adapted to communicate with said central system and for modifying the contents of memory areas of said data storage system.

13. System according to claim 12, wherein said memory areas are organized by records, and that each record contains fields adapted to identifying at least an item code, a position code and a piece of information concerning the sale of said item.

14. System according to claim 1, wherein said data string comprises an SMS (Short Message Service) or MMS (Multimedia Message Service) type message.

15. Method for checking the authenticity of an item, wherein the item is provided with at least an item code adapted to identify said item in an unambiguous way, and wherein said item is sold in a shop provided with a position code which identifies the shop in an unambiguous way, the method comprising the steps of comparing said item code and said position code with item codes and position codes stored in a data storage system.

16. Method according to claim 15, wherein said check is carried out by dialing a telephone number and communicating to an operator an item code and a position code deduced from the examination of the item.

17. Method according to claim 15, wherein said check is carried out by sending an electronic message, in particular an SMS or MMS type message, to said central system.

18. Method according to claim 17, wherein said message contains a data string being organized in such a way as to separately identify an item code and a position code.

19. Method according to claim 18, wherein a central system comprising said data storage system receives said message, decodes said data string, and compares the codes contained in said data string with the codes stored in said data storage system.

20. Method according to claim 19, wherein said central system transmits a return message concerning the authenticity of the item to the user having sent the message to the central system.

21. Method according to one of claims 15, 16, 17, 18, 19 or 20, wherein, for every item, said data storage system also comprises a piece of information concerning the position of the shop empowered to sell.

22. Method according to claim 21, wherein said piece of information consists of geographical coordinates.

23. Method according to claim 21, wherein said piece of information consists of a civic address.

24. Method according to claim 21, wherein said authenticity check is carried out by a user, and wherein the method further comprises the step of comparing a position of said user and the position of the shop empowered to sell stored in said data storage system.

25. Method according to claim 19 wherein said data storage system also comprises said piece of information concerning the position of the shop empowered to sell and wherein the method comprises the step of comparing a position of said user and the position of said shop empowered to sell, wherein said position of said user is detected by tracing the origin of said message.

26. Method according to claim 19 wherein said data storage system also comprises said piece of information concerning the position of the shop empowered to sell and wherein the method comprises the step of comparing a position of said user and the position of said shop empowered to sell, wherein said position of said user is detected through a GPS system being associated with or integrated into the telephone sending said message and is transmitted together with said message.

27. Method according to claim 24, wherein, if said check gives a negative result, said system will inform the police.

28. Method according to claim 24, wherein, if said check gives a negative result, said central system (1) will send a warning message to said user (12).

29. Method according to claim 28, wherein said warning message contains the position of said user.

30. Method according to claim 15, wherein, when an item identified by an item code is sold, said code is marked as no longer on sale in said data storage system.

31. Method according to claim 30, wherein said code is marked as no longer on sale in said data storage system through a terminal located in the shop where the item is sold, said terminal being in communication with said central system.

32. Method according to claim 15, wherein, after the sale of an item identified by an item code, the user activates a warranty of said item by sending an SMS type message to said central system.

33. Method according to claim 15, wherein it comprises an additional phase for tracing the item from the producer to the point of sale.

34. Method according to claim 33, wherein said additional phase provides for:
recording the sender and the receiver of the item in said data storage system;
at the next transfer, checking if the sender corresponds to the receiver recorded in the previous transfer and recording the new receiver in said data storage system.

35-37. (canceled)
